(19) United States
(12) Patent Application Publication
(10) Pub. No.: US 2024/0185576 A1
(43) Pub. Date: Jun. 6, 2024

(54) IMAGE DETERMINATION DEVICE, IMAGE DETERMINATION METHOD, AND RECORDING MEDIUM

(71) Applicant: Panasonic Intellectual Property Management Co., Ltd., Osaka (JP)

(72) Inventors: Yuya SUGASAWA, Osaka (JP); Yoshinori SATOU, Osaka (JP); Hisaji MURATA, Osaka (JP); Jeffery FERNANDO, Osaka (JP); Yao ZHOU, Singapore (SG); Nway Nway AUNG, Singapore (SG)

(21) Appl. No.: 18/284,794

(22) PCT Filed: Mar. 14, 2022
(86) PCT No.: PCT/JP2022/011315

§ 371 Date: Sep. 28, 2023

(30) Foreign Application Priority Data
Apr. 5, 2021 (JP) 2021-064375

(51) Int. Cl. G06V 10/774; G06V 10/70; G06V 10/80

(52) U.S. Cl. CPC G06V 10/774; G06V 10/809; G06V 10/87

(57) ABSTRACT

An image determination device according to the present disclosure includes: a trainer that obtains one or more first models by training machine learning models of one or more types with use of a first training data set including first images and first labels, and obtains one or more second models by training machine learning models of one or more types with use of one or more second training data sets each including second images different from the first images, second labels, and at least part of the first training data set; an image obtainer that obtains a target image; and a determiner that outputs a determination result of a label of the target image obtained by the image obtainer, which is obtained by using, for the target image, at least two models including one of the one or more first models and one of the one or more second models.

### CROSS-REFERENCE OF RELATED APPLICATIONS

This application is the U.S. National Phase under 35 U.S.C. § 371 of International Patent Application No. PCT/JP2022/011315, filed on Mar. 14, 2022, which in turn claims the benefit of Japanese Patent Application No. 2021-064375, filed on Apr. 5, 2021, the entire disclosures of which applications are incorporated by reference herein.

### TECHNICAL FIELD

The present disclosure relates to an image determination device, an image determination method, and a recording medium in each of which machine learning models are used.

### BACKGROUND ART

Patent Literature (PTL) 1 discloses technology for highly precisely detecting an image showing a detection target such as a pedestrian, using learning models. According to PTL 1, one learning model corresponding to a gain of an image captured by image capturing means out of a plurality of pretrained learning models is selected, which allows a detection target that appears in the image to be detected highly precisely.

### CITATION LIST

### Patent Literature

[PTL 1] Japanese Unexamined Patent Application Publication No. 2012-068965

### SUMMARY OF INVENTION

### Technical Problem

However, images captured by the image capturing means may differ from one another due to various causes such as maintenance of the image capturing unit. In this case, a degree of precision may significantly fall even if a detection target is detected by one learning model corresponding to a gain of an image captured by the image capturing means. Furthermore, when it is difficult to adjust a criterion for evaluating a difference of images or when the difference is the one that a person cannot perceive at a glance in the first place, a learning model cannot be selected when a plurality of learning models are prepared or during inspection, and thus a degree of precision in detecting a detection target cannot be improved.

In other words, Patent Literature (PTL) 1 has a problem that a degree of precision in determination cannot be improved if a difference that a person cannot perceive at a glance occurs in an image in a task in which a machine learning model is caused to determine a label of a target image.

The present disclosure has been conceived in view of circumstances as stated above, and is to provide an image determination device and others that can improve a degree of precision in image determination in which machine learning models are used even if the degree of precision falls.

### Solution to Problem

In order to provide such a device, an image determination device according to an aspect of the present disclosure includes: a trainer that obtains one or more first models by training one or more machine learning models of one or more types with use of a first training data set that includes first images and first labels associated with the first images, and obtains one or more second models by training one or more machine learning models of one or more types with use of one or more second training data sets each including second images, second labels associated with the second images, and at least part of the first training data set, the second images being different from the first images; an image obtainer that obtains a target image; and a determiner that outputs a determination result of a label of the target image obtained by the image obtainer, the determination result being obtained by using, for the target image, at least two models that include one of the one or more first models and one of the one or more second models.

Accordingly, even if a degree of precision in image determination in which machine learning models are used falls, the degree of precision can be improved.

Note that these general or specific aspects may be embodied as a device, a method, an integrated circuit, a computer program, or a computer-readable recording medium such as a CD-ROM, or may be embodied as any combination of a system, a method, an integrated circuit, a computer program, and a recording medium.

### Advantageous Effects of Invention

According to the present disclosure, it is possible to provide an image determination device and others that can improve a degree of precision in image determination in which machine learning models are used even if the degree of precision falls.

### BRIEF DESCRIPTION OF DRAWINGS

FIG. 1 is a block diagram illustrating a functional configuration of an image determination device according to an embodiment.

FIG. 2 illustrates an example of a hardware configuration of a computer that achieves, using software, functions of the image determination device according to the embodiment.

FIG. 3 is a diagram for explaining examples of old and new data sets used as training data sets according to the embodiment.

FIG. 4 is a diagram for explaining other examples of old and new data sets used as training data sets according to the embodiment.

FIG. 5 is a diagram for explaining yet other examples of old and new data sets used as training data sets according to the embodiment.

FIG. 6A is a diagram for explaining an example of rule information according to the embodiment.

FIG. 6B is a diagram for explaining another example of rule information according to the embodiment.

FIG. 6C is a diagram for explaining yet another example of rule information according to the embodiment.

FIG. 7 illustrates a concept of a method for selecting, by machine learning, a combination of old and new machine learning models according to the embodiment.

FIG. 8A illustrates examples of machine learning models that are combination targets and a testing data set according to the embodiment.

FIG. 8B illustrates examples of outputs from machine learning models that are combination targets, for images included in the testing data set.

FIG. 9 illustrates an example of a list for prompting a user to select an optimal combination of an old machine learning model and a new machine learning model, according to the embodiment.

FIG. 10 is a flowchart briefly showing an operation of the image determination device according to the present embodiment.

FIG. 11 illustrates training data 1 and training data 2 according to the embodiment.

FIG. 12 qualitatively illustrates degrees of precision achieved by machine learning models for data for training (data set 1) and recent data, according to the embodiment.

FIG. 13 illustrates an example of training data used to train model 1 and model 2 illustrated in FIG. 11.

### DESCRIPTION OF EMBODIMENTS

The following describes in detail embodiments of the present disclosure with reference to the drawings. Note that the embodiments described below each show a particular example of the present disclosure. The numerical values, shapes, materials, standards, elements, the arrangement and connection of the elements, steps, the order of processing the steps, and others indicated in the following embodiments are mere examples, and are not intended to limit the present disclosure. In addition, among the elements in the following embodiments, elements not recited in any of the independent claims defining the broadest concept of the present disclosure are described as optional elements. Furthermore, the drawings do not necessarily provide strictly accurate illustration. In the drawings, the same numeral is given to the substantially same configuration, and a redundant description thereof may be omitted or simplified.

### Embodiment

First, an image determination device and an image determination method according to the present embodiment are to be described.

### 1. Image Determination Device 10

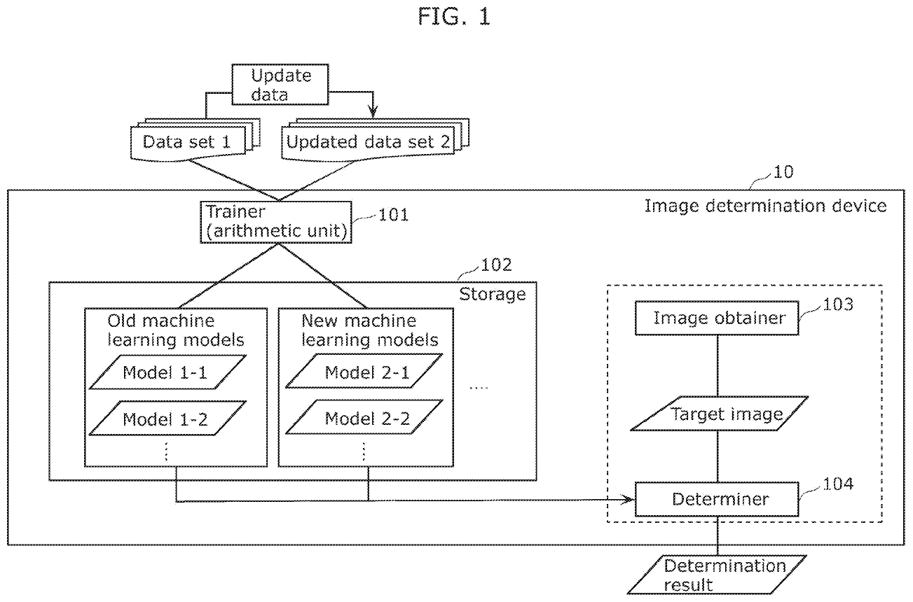

In the following, a configuration of image determination device 10 according to the present embodiment, for instance, is to be described. FIG. 1 is a block diagram illustrating a functional configuration of image determination device 10 according to the present embodiment.

Image determination device 10 is embodied using, for instance, a computer, and can improve a degree of precision in image determination in which machine learning models are used even if the degree of precision has decreased.

In the present embodiment, image determination device 10 includes trainer 101, storage 102, image obtainer 103, and determiner 104, as illustrated in FIG. 1. Note that image obtainer 103 and determiner 104 may be included in a device separate from trainer 101, and in this case, the device may include memory or a storage that stores therein models 1-1 to 2-2 stored in storage 102.

### [1-1. Configuration of Hardware]

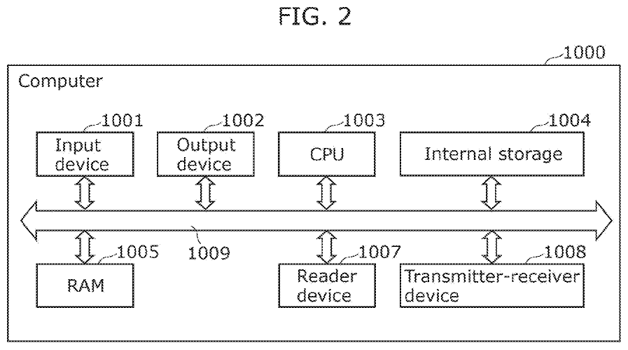

FIG. 2 illustrates an example of a hardware configuration of computer 1000 that achieves, using software, functions of image determination device 10 according to the present embodiment.

Before explaining a functional configuration of image determination device 10 according to the present embodiment, an example of a hardware configuration of image determination device 10 according to the present embodiment is to be described with reference to FIG. 2.

Computer 1000 includes input device 1001, output device 1002, central processing unit (CPU) 1003, internal storage 1004, random access memory (RAM) 1005, reader device 1007, transmitter-receiver device 1008, and bus 1009, as illustrated in FIG. 2. Input device 1001, output device 1002, CPU 1003, internal storage 1004, RAM 1005, reader device 1007, and transmitter-receiver device 1008 are connected by bus 1009.

Input device 1001 is a device that serves as a user interface such as an input button, a touch pad, or a touch-panel display, and receives user operation. Note that input device 1001 may be configured to receive voice operation and remote operation made by, for instance, a remote control, in addition to a touch operation made by a user.

Output device 1002 also serves as input device 1001, is configured of a touch pad or a touch-panel display, for instance, and notifies a user of information that the user should be informed of.

Internal storage 1004 is a flash memory, for instance. Internal storage 1004 may prestore therein at least one of a program for achieving functions of image determination device 10 or an application that uses a functional configuration of image determination device 10. Internal storage 1004 may store therein models 1-1 to 2-2, for instance.

RAM 1005 is a random access memory, and is used to store data, for instance, when executing a program or an application.

Reader device 1007 reads information from a recording medium such as a universal serial bus (USB) memory. From the recording medium on which a program or an application as above is recorded, reader device 1007 reads out and stores the program or the application into internal storage 1004.

Transmitter-receiver device 1008 is a communication circuit for wireless or wired communication. Transmitter-receiver device 1008 may communicate with a server device connected to a network, for example, and may download and store a program or an application as above into internal storage 1004.

CPU 1003 is a central processing unit, makes in RAM 1005 a duplicate of the program or the application stored in internal storage 1004, and sequentially reads out from RAM 1005 and executes instructions included in the program or the application.

Next, functional elements of image determination device 10 according to the present embodiment, for instance, are to be described.

In the present embodiment, a description is given, assuming that image determination device 10 is configured as an inspection device that makes determination on inspection images of products using machine learning. In the following, a description is given, assuming that as an example of an inspection image of a product, the inspection image results from optically capturing a wafer on which a semiconductor circuit is provided, yet the present disclosure is not limited thereto. An inspection image of a product may result from optically capturing a cross sectional view of a secondary battery, for example, and thus may be a two-dimensional image obtained by optically capturing an image of a product.

### [1-2. Trainer 101]

Trainer 101 is an arithmetic unit that trains machine learning models, using, for instance, data set 1 that is training data.

More specifically, trainer 101 obtains one or more first models by training one or more machine learning models of one or more types with use of a first training data set that includes first images and first labels associated with the first images. In the present embodiment, trainer 101 obtains model 1-1, mode 1-2, and so on by training one or more models of one or more types with use of, as training data, data set 1 provided in advance.

Trainer 101 obtains one or more second models by training one or more machine learning models of one or more types with use of one or more second training data sets. Here, each of the one or more second training data sets includes second images different from the first images and second labels associated with the second images, and at least part of the first training data set. In the present embodiment, trainer 101 obtains model 2-1, model 2-2, and so on by training one or more models of one or more types with use of, as training data, updated data set 2 that includes at least partial data of data set 1 and new data (updated data).

Note that model 2-1, model 2-2, and so on are machine learning models obtained after model 1-1, model 1-2, and so on are obtained. Accordingly, as illustrated in FIG. 1, model 1-1, model 1-2, and so on can be collectively referred to as old machine learning models, and model 2-1, model 2-2, and so on can be collectively referred to as new machine learning models.

### <Data Set>

In the following, data set 1 and updated data set 2 are to be described.

Data set 1 is a training data set that includes images collected before image determination device 10 is introduced in an inspection process, that is, before inspection is conducted. Updated data set 2 is a training data set that includes images collected after a predetermined period has elapsed since image determination device 10 is introduced in the inspection process. Accordingly, updated data set 2 is obtained temporally after data set 1. Thus, updated data set 2 can be referred to as a new data set, whereas data set 1 can be referred to as an old data set.

In the present embodiment, images included in data set 1 and updated data set 2 are inspection images of products obtained in a predetermined period, for example. Here, for example, each of images (first images) included in data set 1 may be an inspection image obtained in a first period included in the predetermined period, and each of images (second images) included in data set 2 may be an inspection image obtained in a period after the first period, which is included in the predetermined period.

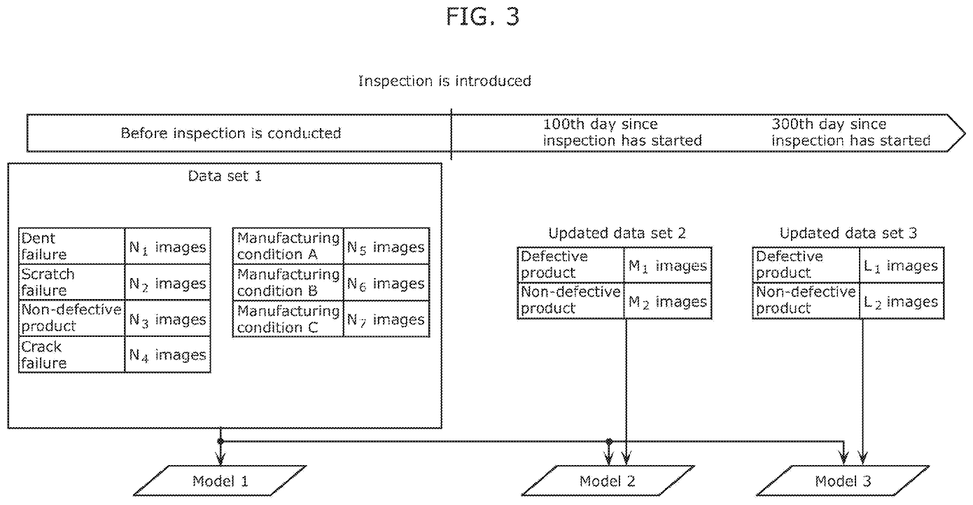

FIG. 3 is a diagram for explaining examples of old and new data sets used as training data sets according to the embodiment.

Data set 1 is an old data set that includes a great number of inspection images collected before inspection is conducted and labels associated with the great number of inspection images. In the example of data set 1 illustrated in FIG. 3, N₁ inspection images are associated with a label indicating dent failure, N₂ inspection images are associated with a label indicating scratch failure, N₃ inspection images are associated with a label indicating a non-defective product, and N₄ inspection images are associated with a label indicating crack failure. Data set 1 includes images collected under various conditions in a well-balanced manner. For example, N₅ images are collected under manufacturing condition A, N₆ images are collected under manufacturing condition B, and N₇ images are collected under manufacturing condition C, while N₅, N₆, and N₇ are all greater than or equal to a predetermined number.

Updated data set 2 is a new data set that includes inspection images collected in haste due to a decrease in a degree of precision in determination made by model 1 after the inspection is introduced, that is, on the 100th day of the inspection, for example, and labels associated with the inspection images. In the example of updated data set 2 illustrated in FIG. 3, M₁ inspection images are each associated with a label indicating a defective product, whereas M₂ inspection images are each associated with a label indicating a non-defective product.

Note that FIG. 3 further illustrates updated data set 3. Updated data set 3 is a new data set that includes inspection images collected in haste due to decreases in the degrees of precision in determinations made by model 1 and model 2 on the 300th day of the inspection, for example, and labels associated with the inspection images. In the example of updated data set 3 illustrated in FIG. 3, L₁ inspection images are each associated with a label indicating a defective product, whereas L₂ inspection images are each associated with a label indicating a non-defective product.

Accordingly, updated data set 2 includes inspection images obtained after data set 1 is obtained, and updated data set 3 includes inspection images obtained after data set 1 is obtained and after updated data set 2 is obtained.

Note that FIG. 3 illustrates that data set 1 is used as a training data set for model 1, and data set 1 and updated data set 2 are used as training data sets for model 2. FIG. 3 further illustrates data set 1 and updated data set 3 are used as training data sets for model 3 obtained after model 2 is obtained. FIG. 3 illustrates that inspection is conducted using model 1 when the inspection is introduced, the inspection is conducted using both models 1 and 2 on and after the 100th day since the inspection has started, and the inspection is conducted using both models 1 and 3 on and after the 300th day since the inspection has started. Of course, models 1 to 3 may be all used to conduct the inspection on and after the 300th day since the inspection has started.

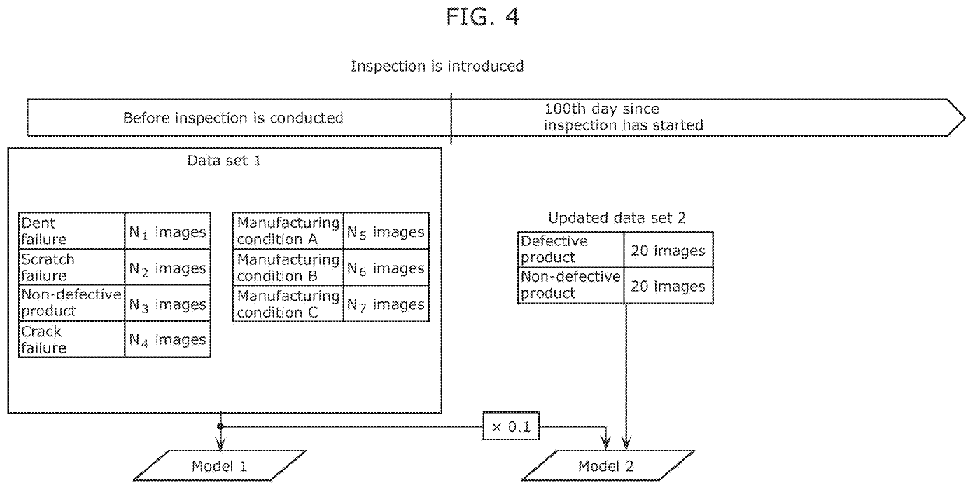

FIG. 4 is a diagram for explaining other examples of old and new data sets used as training data sets according to the embodiment.

As compared with FIG. 3, FIG. 4 does not illustrate an example of updated data set 3, but illustrates data set 1 the same as that in FIG. 3. Updated data set 2 is a new data set that includes 40 inspection images collected in haste due to a decrease in the degree of precision in determination made by model 1 after inspection is introduced, that is, on the 100th day of the inspection, for example, and 40 labels associated with the 40 inspection images. In the example of updated data set 2 illustrated in FIG. 4, 20 inspection images are each associated with a label indicating a defective product, whereas 20 inspection images are each associated with a label indicating a non-defective product.

Accordingly, in the example illustrated in FIG. 4, updated data set 2 includes inspection images after data set 1 is obtained. In the examples illustrated in FIG. 4, data set 1 is used as a training data set for model 1, and part of data set 1 and updated data set 2 are used as training data sets for model 2. If updated data set 2 includes a small number of inspection images, this is because the number of inspection images included in data set 1 is decreased and then the remaining inspection images are added to the training data set for model 2. Note that FIG. 4 illustrates an example in which as the training data set for model 2, 10% (×0.1) of data set 1 is used as part of data set 1, but the proportion is not limited thereto and can be arbitrarily determined. For example, images other than dent failure images in data set 1 are excluded, and the remaining images can be added. FIG. 4 illustrates that inspection is conducted using model 1 when the inspection is introduced, and the inspection is conducted using both models 1 and 2 on and after the 100th day since the inspection has started, similarly to FIG. 3.

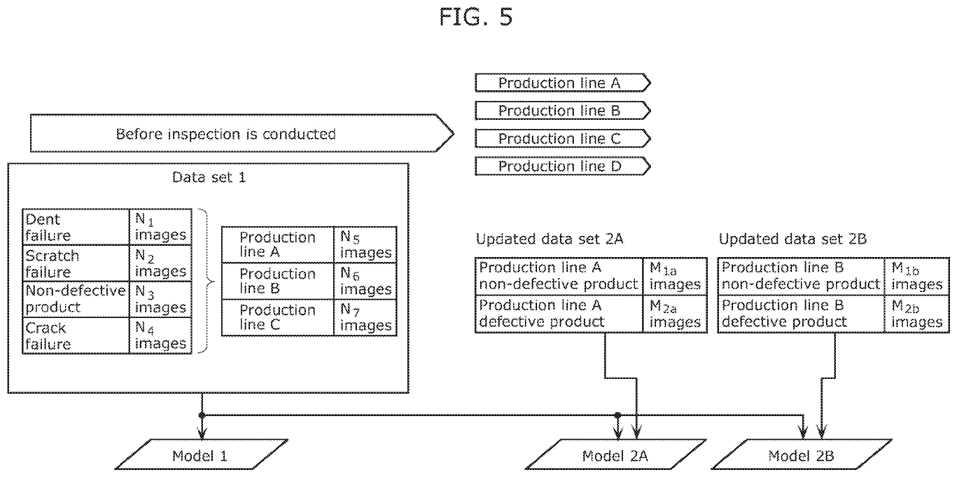

As described with reference to FIG. 3 and FIG. 4, in old and new data sets used as training data sets, the number of inspection images included in the new data set is less than the number of inspection images included in the old data set. This relation can be utilized when a plurality of production lines for products are used. Thus, when the same products are manufactured using the plurality of production lines, it is difficult to collect inspection images enough to ensure a sufficient degree of precision for training machine learning models for all the production lines, since this requires great many processes. Accordingly, inspection images collected evenly from the plurality of production lines may be used as an old data set, and inspection images collected from a particular production line and having less variations may be used as a new data set for model 1 and model 2. An example in this case is to be described with reference to FIG. 5.

FIG. 5 is a diagram for explaining yet other examples of old and new data sets used as training data sets according to the embodiment. FIG. 5 illustrates an example in the case where a relation between old and new data sets is utilized for inspection images that can be collected from the plurality of production lines for manufacturing products.

Data set 1 includes a great number of inspection images collected evenly from the plurality of production lines, and labels associated with the great number of inspection images. In the example of data set 1 illustrated in FIG. 5, N₁ inspection images are each associated with a label indicating dent failure, N₂ inspection images are each associated with a label indicating scratch failure, N₃ inspection images are each associated with a label indicating a non-defective product, and N₄ inspection images are each associated with a label indicating crack failure. These images include N₅ images collected from production line A, N₆ images collected from production line B, and N₇ images collected from production line C, while N₅, N₆, and N₇ are all a predetermined number or more.

Updated data set 2A includes, as a new data set, inspection images collected from production line A and labels associated with the inspection images, for example. In the example of updated data set 2A illustrated in FIG. 5, M₁ₐ inspection images are each associated with a label indicating a non-defective product, whereas M₂ₐ inspection images are each associated with a label indicating a defective product.

Similarly, updated data set 2B includes, as a new data set, inspection images collected from production line B and labels associated with the inspection images, for example. In the example of updated data set 2B illustrated in FIG. 5, M_{1b} inspection images are each associated with a label indicating a non-defective product, whereas M_{2b} inspection images are each associated with a label indicating a non-defective product.

The same applies to updated data sets 2C and 2D (not illustrated) collected from production lines C and D, and thus a description thereof is omitted.

In this manner, while data set 1 includes inspection images collected evenly from all the production lines, updated data sets 2A to 2D each include inspection images obtained from a particular production line.

Note that FIG. 5 illustrates that data set 1 is used as a training data set for model 1, and data set 1 and updated data set 2A are used as training data sets for model 2A used for production line 2A. Similarly, FIG. 5 illustrates that data set 1 and updated data set 2B are used as training data sets for model 2B used for production line 2B. The same applies to training data sets for models 2C and 2D used for production lines 2C and 2D, and thus a description thereof is omitted. This is because a proportion of inspection images obtained during inspection for a particular production line, which are included in a training data set for model 2A, for instance, used for the specific production line, is higher than a proportion of inspection images obtained during inspection for the particular production line, which are included in the training data set for model 1.

In this manner, when inspection is introduced, model 1 is combined with each of models 2A to 2D, and the combinations are used to conduct inspection for the production lines.

### [1-3. Storage 102]

Storage 102 is configured of, for instance, a hard disk drive (HDD) or a memory, and stores therein old machine learning models and new machine learning models trained by trainer 101. In the present embodiment, storage 102 stores therein, for example, model 1-1, model 1-2, . . . , model 2-1, mode 2-2, and so on, trained by trainer 101.

### <Machine Learning Models>

In the following, machine learning models used in the present embodiment are to be described.

Model 1-1, model 1-2, and so on are machine learning models of one or more types trained using same data set 1 as a training data set. Model 2-1, model 2-2, and so on are machine learning models of one or more types trained using the same training data set that includes at least part of data set 1 and updated data set 2.

Here, types of machine learning models may be models trained by supervised learning, such as a logistic regression model, a support-vector machine, and a deep neural network (DNN). In addition, the types of machine learning models may also include an autoencoder and may also include a non-defective product model that is generated using data indicating non-defective products and outputs an outlier as an abnormal level. Thus, the machine learning models according to the present embodiment may be of one or more of the types stated as examples.

Note that storage 102 may store therein not only trained models 1-1, 1-2, . . . , 2-1, 2-2, and so on illustrated in FIG. 1, but also models N-M (N and M are positive integers) such as models 3-1 and 3-2.

When machine learning models of only one type are applied, trained models 1-1, 1-2, . . . , 2-1, 2-2, and so on illustrated in FIG. 1 are shown as models 1 and 2. When machine learning models of two or more types are applied, M in model N-M shows its type and N in model N-M shows whether a training data set that has been used is the same or different. Thus, models N-M having the same value for M indicate that the models are machine learning models of the same type, whereas models N-M having the same value for N indicate that the models have been trained using the same training data set.

### [1-4. Image Obtainer 103]

Image obtainer 103 obtains a target image.

In the present embodiment, image obtainer 103 obtains, as a target image, an inspection image obtained during inspection for a product manufactured by a production line, for example.

### [1-5. Determiner 104]

Determiner 104 outputs a determination result of a label of a target image obtained by image obtainer 103, the determination result being obtained by using, for the target image, at least two models that include one of one or more first models and one of one or more second models. Here, determiner 104 may combine, into a combined result, one or more determination results obtained by the one or more first models and one or more determination results obtained by the one or more second models in line with a preset rule, and output the combined result as a determination result of a label of the target image.

For example, determiner 104 is assumed to use (both of) two models that include model 1-1 and model 1-2, for example, as an old machine learning model and a new machine learning model illustrated in FIG. 1. In this case, determiner 104 determines whether a product captured in a target image is non-defective or defective (good or poor) as a label of the target image by using model 1-1 and model 2-1, and outputs a determination result obtained by combining the determination results in line with the preset rule.

<Preset Rule and Determination Result Obtained by being Combined>

Here, a preset rule and a determination result obtained by combining determination results are to be described with use of examples.

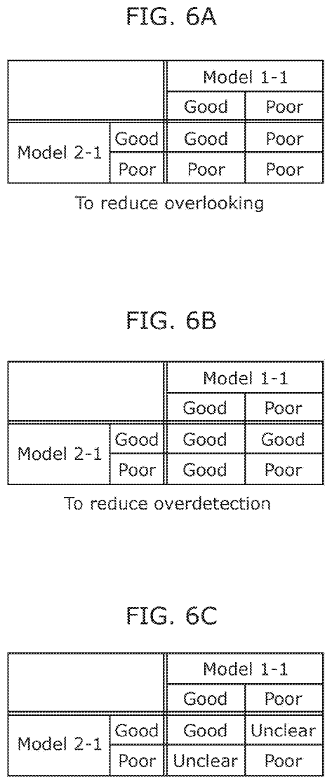

FIG. 6A is a diagram for explaining an example of rule information according to the embodiment. FIG. 6A illustrates an example in the case where a rule for reducing overlooking during inspection is preset. FIG. 6A illustrates determination results each obtained by determiner 104 determining whether a product captured in a target image is non-defective or defective (good or poor) using, for example, two models 1-1 and 2-1, and combining determination results in line with the preset rule for reducing overlooking.

Specifically, FIG. 6A illustrates an example in the case where good is shown as a combined determination result, only when both of outputs (determination results) from model 1-1 and model 2-1 indicate good.

FIG. 6B is a diagram for explaining another example of rule information according to the embodiment. FIG. 6B illustrates an example in the case where a rule for reducing overdetection during inspection is preset. FIG. 6B illustrates determination results each obtained by determiner 104 determining whether a product captured in a target image is non-defective or defective (good or poor) using, for example, two models 1-1 and 2-1, and combining determination results in line with the preset rule for reducing overdetection.

Specifically, FIG. 6B illustrates an example in the case where good is shown as a combined determination result when an output (a determination result) from one of model 1-1 or model 2-1 indicates good.

FIG. 6C is a diagram for explaining yet another example of rule information according to the embodiment. FIG. 6C illustrates an example in the case where a rule is preset, which is for reducing determination of a product being defective although the product is determined to be non-defective in line with the rule illustrated in FIG. 6A. FIG. 6C also illustrates determination results each obtained by determiner 104 determining whether a product captured in a target image is non-defective or defective (good or poor) using, for example, two models 1-1 and 2-1, and combining determination results in line with the preset rule.

FIG. 6C illustrates an example in which good is shown as a combined determination result only when both of the determination results obtained by model 1-1 and model 1-2 show good, whereas when an output (a determination result) from one of model 1-1 or model 2-1 indicates poor, unclear is shown so that a person is prompted to check.

### <Method 1 for Selecting Combination of Old Machine Learning Model and New Machine Learning Model>

In the above, the case where determiner 104 uses (both of) two models that are, for example, model 1-1 and model 2-1 as a combination of an old machine learning model and a new machine learning model that are illustrated in FIG. 1 has been described as an example, but an example of the combination is not limited thereto.

For example, a combination of an old machine learning model and a new machine learning model may be selected by machine learning.

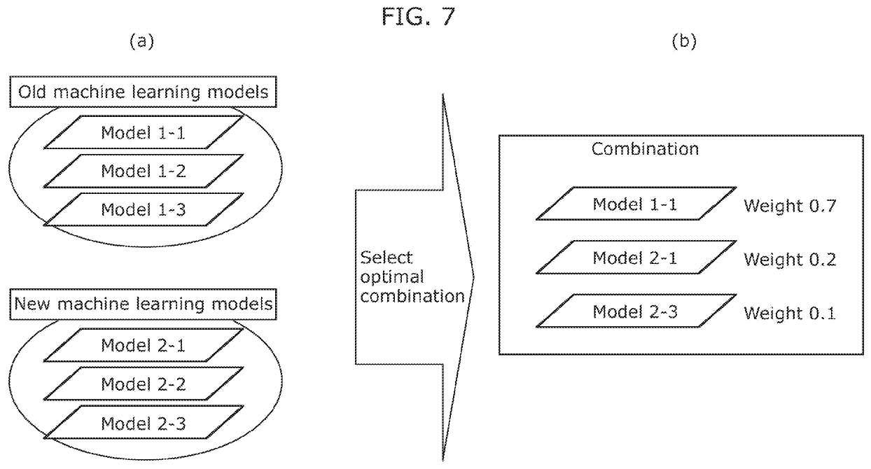

FIG. 7 illustrates a concept of a method for selecting, by machine learning, a combination of old and new machine learning models according to the embodiment.

Part (a) of FIG. 7 illustrates an example in which trained models 1-1, 1-2, and 1-3 can be used as old machine learning models, and trained models 2-1, 2-2, and 2-3 can be used as new machine learning models. Part (b) of FIG. 7 illustrates that a combination obtained by selecting an optimal combination from among all the combinations of the models is a combination of models 1-1, 2-1, and 2-3.

For example, logistic regression may be performed using a combination of two or three models selected from all the new and old machine learning models illustrated in (a) of FIG. 7, and an optimal combination may be selected based on the obtained degree of precision in determination. Note that instead of logistic regression, machine learning such as a support-vector machine, a random forest, gradient boosting, a neural network, or deep learning may be used.

For example, determiner 104 may select an optimal combination of old and new machine learning models, using a machine learning model trained separately. More specifically, determiner 104 may further cause a third machine learning model, which has been trained using inputs that are one or more outputs from one or more first models and one or more outputs from one or more second models, to select a combination of at least one of the one or more first models and at least one of the one or more second models. Determiner 104 may output a determination result of a label of a target image obtained by using the selected combination.

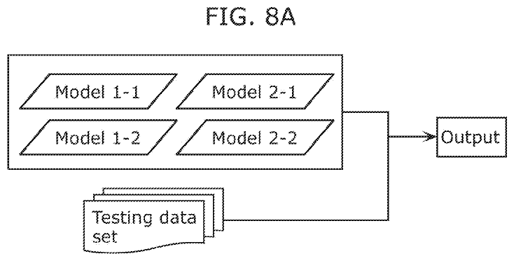

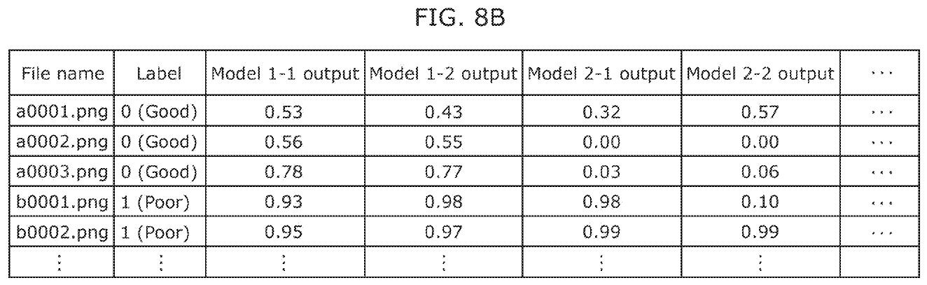

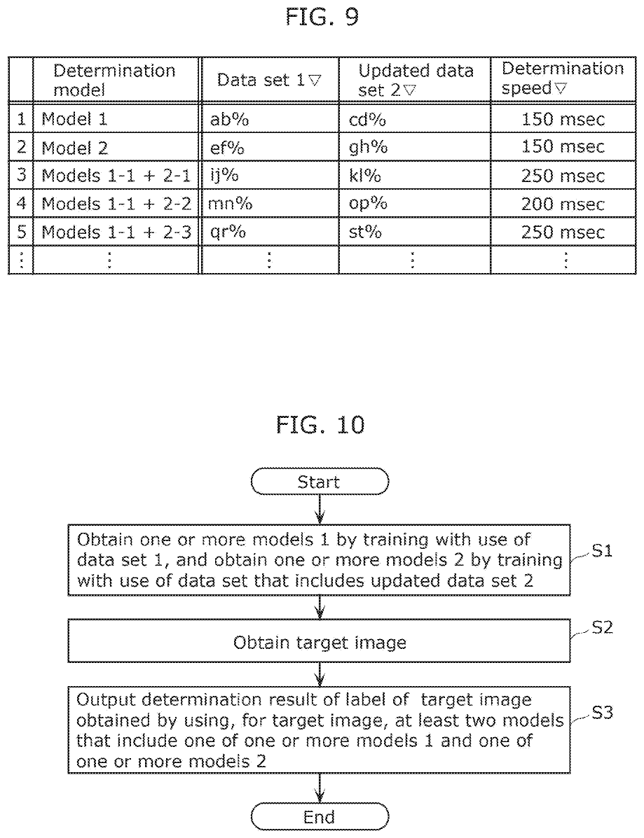

Here, a method for training a machine learning model for selecting an optimal combination of old and new machine learning models (that is, for selecting a combination) and a method for optimally combining old and new machine learning models is to be described with reference to FIG. 8A, FIG. 8B, and FIG. 9.

FIG. 8A illustrates examples of machine learning models that are combination targets and a testing data set according to the embodiment. FIG. 8B illustrates examples of outputs from machine learning models that are combination targets, for images included in the testing data set. The testing data set includes, for example, part of training data that includes data set 1 and updated data set 1, for instance, described above.

FIG. 8A illustrates, as examples of machine learning models that are combination targets, trained models 1-1 and 1-2 that are old machine learning models and trained models 2-1 and 2-2 that are new machine learning models. The testing data set includes plural images and is used to be input to machine learning models.

Thus, if the images included in the testing data set are input to the machine learning models that are combination targets, outputs (determination results) for the images from the machine learning models as illustrated in FIG. 8B can be obtained.

Next, n outputs are selected from among the outputs from machine learning models as illustrated in FIG. 8B, for example, and used as explanatory variables, and a machine learning model for selecting a combination that predicts labels such as 0 (good) and 1 (poor) using explanatory variables is created. If a description is given using the example in FIG. 8A, combinations when n=2 are (model 1-1, model 2-1), (model 1-1, model 2-2), (model 1-2, model 2-1), and (model 1-2, model 2-2).

Note that less explanatory variables may be used, by utilizing regularization such as L1 or L2 regularization. In this case, a machine learning model for selecting a combination can be created while excluding outputs that are not used as results. A combination used to create a machine learning model for selecting a combination is not limited to a combination that includes at least one new machine learning model and at least one old machine learning model, and may be a combination that includes only new machine learning models or only old machine learning models.

In this manner, the degree of precision achieved by the created machine learning model for selecting a combination can be evaluated, and a combination that achieves a high degree of precision can be selected.

Thus, determiner 104 can determine and select a combination of new and old machine learning models that achieve a high degree of precision, by using a machine learning model for selecting a combination, which receives inputs that are outputs from old and new machine learning models.

### <Method 2 for Selecting Combination of Old and New Machine Learning Models>

The above has described a method for selecting a combination of old and new machine learning models by machine learning, but the present embodiment is not limited thereto. Information on degrees of precision achieved by combinations may be displayed on a graphical user interface (GUI) and a user may be prompted to select a combination.

More specifically, image determination device 10 may include a display that displays a degree of precision of a determination result of a label of a target image obtained by using, for a testing data set, a combination of at least one of one or more first models and at least one of one or more second models. The testing data set includes part of a first training data set and part of each of one or more second training data sets, for example.

Thus, image determination device 10 may further include a display or a display device. Of course, image determination device 10 may be connected to an external display or an external display device. Image determination device 10 may cause the display or the display device to display a list of degrees of precision of the old machine learning models, degrees of precision of the new machine learning models, and degrees of precision of combinations of the old machine learning models and the new machine learning models, and prompt a user to select an optimal combination.

FIG. 9 illustrates an example of a list for prompting a user to select an optimal combination of an old machine learning model and a new machine learning model, according to the embodiment. FIG. 9 illustrates degrees of precision (%) when two types of sets, that is, data set 1 and updated data set 2, are used as an example of a testing data set. As an example of a basis for determination when selecting a combination, speeds for the determinations (takt time) are shown.

The user may select an optimal combination of an old machine learning model and a new machine learning model, by looking at a list as illustrated in FIG. 9.

Note that easy operations such as searching, narrowing down, and sorting can be made on the list as illustrated in FIG. 9. In this case, not only the user, but also determiner 104 may sort the list based on the degree of precision for data set 1, and select a combination that achieves at least a predetermined degree of precision such as at least 90% for data set 1 and the highest degree of precision for updated data set 2. Determiner 104 may sort the list based on the determination speed (takt time) and select a combination with the highest degree of precision, which makes determination at a predetermined determination speed or less.

### 2. Operation of Image Determination Device 10

An example of operation of image determination device 10 having a configuration as above is to be described as follows.

FIG. 10 is a flowchart briefly showing an operation of image determination device 10 according to the present embodiment.

First, image determination device 10 obtains one or more models 1 by training in which data set 1 is used as training data, and obtains one or more models 2 by training in which a data set that includes updated data set 2 is used as training data (S1). More specifically, trainer 101 of image determination device 10 obtains one or more first models by training one or more machine learning models of one or more types using a first training data set that includes first images and first labels associated with the first images. Trainer 101 obtains one or more second models by training one or more machine learning models of one or more types, using one or more second training data sets. Here, each of the one or more second training data sets includes second images different from first images, second labels associated with the second images, and at least part of the first training data set.

Next, image determination device 10 obtains a target image (S2). In the present embodiment, image obtainer 103 obtains, as a target image, an inspection image obtained during inspection for a product manufactured by a production line, for example.

Next, image determination device 10 outputs a determination result of a label of the target image obtained by using, for the target image, at least two models that include one of one or more models 1 and one of one or more models 2 (S3). More specifically, determiner 104 of image determination device 10 outputs a determination result of a label of the target image obtained by image obtainer 103, which is obtained by using, for the target image, at least two models that include one of the one or more first models and one of the one or more second models. Note that determiner 104 may combine, into a combined result, one or more determination results obtained by the one or more first models and one or more determination results obtained by the one or more second models in line with a preset rule, and output the combined result as a determination result of the label of the target image. In this manner, in the present embodiment, image determination device 10 can determine whether a product captured in the target image is non-defective or defective (good or poor), by using all of at least two machine learning models.

### 3. Advantageous Effects and Others

For example, with regard to model 1 trained, in order to conduct inspection, using an old data set before the inspection is introduced, if the degree of precision in determination by model 1 decreases after the inspection has started due to various causes such as maintenance, model 2 is trained using a new data set collected in haste. An inspection image included in the new data set, for which a degree of precision in determination by model 1 has decreased, has a difference that a person can hardly notice at a glance in comparison to an inspection image included in the old data set.

In the comparative example, inspection is conducted using only model 2 obtained by retraining model 1 using a new data set. However, the degree of precision achieved by model 2 for an inspection image similar to an image included in the old data set may be lower than that of model 1.

In view of this, according to the present embodiment, inspection is conducted using both (a combination of) model 1 and model 2, and thus the degree of precision can be maintained high for an inspection image similar to an image included in the old data set and for an inspection image similar to an image included in the new data set.

In this manner, according to the present embodiment, even if a degree of precision in determination for an image using a machine learning model decreases, the degree of precision can be improved.

Note that the degree of precision may be not only accuracy, but also at least one of or a combination of at least two of precision, recall, F-measure calculated by a harmonic mean of precision and recall, or accuracy.

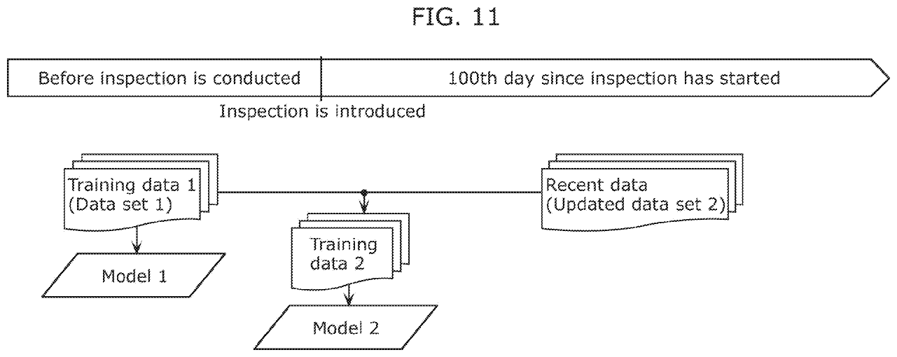

FIG. 11 illustrates training data 1 and training data 2 according to the embodiment. Training data 1 is data set 1 described above, for example. In the following, training data 1 is data set 1 that includes, for example, 100,000 inspection images for inspecting a wafer on which a semiconductor circuit is formed, and the 100,000 inspection images are collected before introducing inspection in which a machine learning model is used. In this case, model 1 is a machine learning model trained using data set 1 as training data 1.

Training data 2 includes recent data and part of training data 1. Model 2 is a machine learning model trained using training data 2. Recent data is an updated data set stated above, for example, and includes inspection images collected after inspection in which a machine learning model is used is introduced (after the inspection is introduced). Here, recent data indicates inspection images collected in a period in which the degree of precision in determination has decreased after an elapse of a certain period such as on the 100th day, for example, after the inspection is introduced. Note that the degree of precision in determination decreases due to various causes such as maintenance of an inspection device conducted after the inspection is introduced.

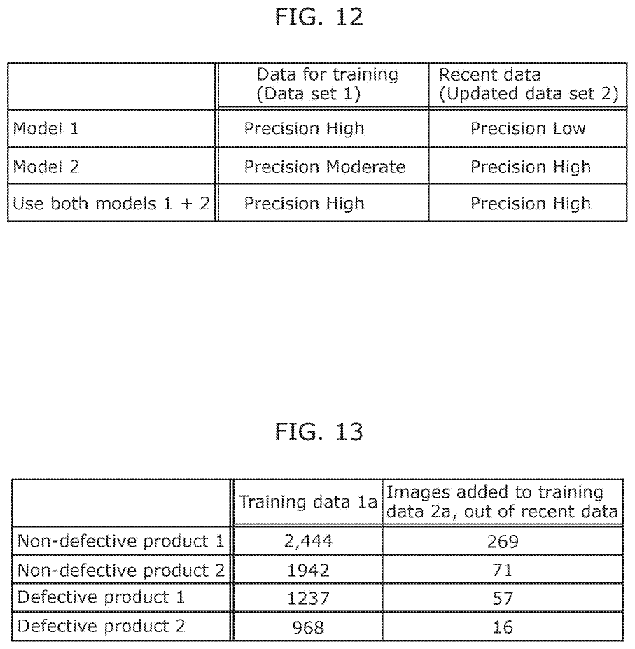

FIG. 12 qualitatively illustrates degrees of precision achieved by machine learning models for data for training (data set 1) and recent data, according to the embodiment. FIG. 12 illustrates calculated degrees of precision of model 1 and model 2, using, as testing data sets, data set 1 used as training data 1 and recent data used being included in training data 2.

As illustrated in FIG. 12, the degree of precision achieved by model 1 for recent data is low, but in contrast, the degree of precision achieved by model 2 for the recent data is high. However, model 2 is trained using training data 2 that includes data set 1 the proportion of which is lower than the proportion thereof in training data 1, and thus the degree of precision achieved by model 2 for data set 1 may be slightly lower than that of model 1. Thus, the degree of precision for data for training, that is, data set 1 is high with model 1 as illustrated in FIG. 12, but may be moderate with model 2 and thus may be lower than the degree with model 1. Accordingly, by merely retraining model 1 using training data 2 resulting from collecting and adding, to the data for training, recent data in a period in which the degree of precision in determination has decreased, the degree of precision for an inspection image similar to the data for training may be decreased, although the degree of precision for an inspection image similar to recent data can be increased. A difference generated in recent data cannot be perceived by a person at a glance, and thus a cause of generating the difference cannot be identified, and whether the cause will be overcome in future cannot be predicted. In view of this, it is necessary to maintain a high degree of precision for not only recent data, but also for data set 1.

In view of this, in the present embodiment, since, for example, model 1 and model 2 are both used (combined), the degree of precision for data for training, that is, data set 1 and the degree of precision for recent data can be maintained high.

Next, about how much the degree of precision improves by training model 2 using training data 2 resulting from adding recent data that includes a small number of inspection images to training data 1 (data for training) that includes a great number of inspection images was examined, and thus the result thereof is to be described.

FIG. 13 illustrates an example of training data used to train model 1 and model 2 illustrated in FIG. 11.

Training data 1a in FIG. 13 is an example of training data 1 described above, and training data 2a is an example of training data 2 described above. In the example illustrated in FIG. 13, training data 1a includes 4386 inspection images resulting from 2444+1942 images as data determined to be non-defective and 2205 inspection images resulting from 1237+968 images as data determined to be defective. Training data 2a includes 340 inspection images resulting from 269+71 images as data determined to be non-defective and 73 inspection images resulting from 57+16 images as data determined to be defective.

Further, as testing data for testing degrees of precision in determination by trained models 1 and 2, part of recent data used in training data 2a stated above was used.

As a result, model 1 overdetected, or stated differently, determined 1967 images as showing defective products, out of 7481 inspection images showing non-defective products, which are included in testing data. On the other hand, model 2 overdetected, or stated differently, determined 155 images as showing defective products, out of 7481 inspection images showing non-defective products, which are included in testing data.

Thus, it was acknowledged that for the most recent data not used in training data 2a, a false negative rate of model 1 was 26.3%, whereas a false negative rate of model 2 was significantly improved to 2.07%.

Accordingly, it can be seen that the degree of precision is improved by training model 2 using training data 2 resulting from adding recent data that includes a small number of inspection images to training data 1 (data for training) that includes a great number of inspection images.

### Other Embodiments

The above has been described image determination device 10 and others according to the present disclosure, based on embodiments, yet the present disclosure is not limited to the embodiments. The scope of the present disclosure includes embodiments resulting from applying various modifications, which may be conceived by those skilled in the art, to the embodiments, and other embodiments constructed by combining some elements in the embodiments, without departing from the gist of the present disclosure.

(1) For example, a description has been given, assuming that an old data set used in the first training data, or in other words, data set 1 itself is not updated, yet the present disclosure is not limited thereto. Data set 1 updated using updated data set 2 collected in haste may be used as first training data to retrain model 1 in the next retraining.

(2) In the above embodiments, updated data set 2 is created by adding data to the first training data, yet the embodiments are not limited thereto. If data set 2 collected in haste has a sufficient amount, such data set 2 itself may be used as updated data set 2 to train model 2, rather than adding data to the first training data.

(3) In the above embodiments, determiner 104 included in image determination device 10 outputs a determination result of a label of a target image, using two or more machine learning models, yet the embodiments are not limited thereto. Rule determination may be further made before or after a label of a target image is determined using two or more machine learning models. The rule determination can be considered to be determination based on detecting whether a determination target is included in a target image, and in this case, if the determination target is not included in the target image, determiner 104 may not make determination for the target image using two or more machine learning models. The determination based on detecting whether a determination target is included in a target image may be determination as to whether a determination target is captured in the target image or as to whether information of, for instance, brightness of a target image is included in an applicable range in which such determination can be made.

Further, embodiments shown in the following may be included in the scope of one or more aspects of the present disclosure.

(4) Some of the elements included in image determination device 10 described above may be a computer system that includes a microprocessor, ROM, RAM, a hard disk unit, a display unit, a keyboard, and a mouse, for instance. A computer program is stored in the RAM or the hard disk unit. The operation of the microprocessor in accordance with the computer program allows each element to achieve its functionality. Here, the computer program includes a combination of instruction codes indicating instructions to a computer in order to achieve predetermined functionality.

(5) Some of the elements included in image determination device 10 described above may be configured of a single system large scale integration (LSI: large scale integrated circuit). The system LSI is a super multi-function LSI that is manufactured by integrating multiple components in one chip, and is specifically a computer system configured so as to include a microprocessor, a read only memory (ROM), a random access memory (RAM), and so on. A computer program is stored in the RAM. The system LSI accomplishes its functionality by the microprocessor operating in accordance with the computer program.

(6) Some of the elements included in image determination device 10 described above may be configured of an IC card or a single module that can be attached to or detached from various devices. The IC card or the module is a computer system that includes a microprocessor, ROM, and RAM, for instance. The IC card or the module may include a super multi-function LSI stated above. The IC card or the module accomplishes its functionality by the microprocessor operating in accordance with the computer program. The IC card or the module may have tamper resistant properties.

(7) Some of the elements included in image determination device 10 described above may be a recording medium that can read, using a computer, the computer program or the digital signal, such as, for example, a flexible disk, a hard disk, CD-ROM, MO, DVD, DVD-ROM, DVD-RAM, a Blu-ray disc (registered trademark) (BD), or a semiconductor memory. Some of the elements included therein may be the digital signal recorded on such a recording medium.

Further, some of the elements included in image determination device 10 described above may transfer the computer program or the digital signal via, for instance, data broadcasting or a network typified by telecommunication lines, wireless or wired communication lines, and the Internet.

(8) The present disclosure may be a method described above. The disclosure may be a computer program that achieves the method using a computer, or may be a digital signal that includes the computer program.

(9) The present disclosure may be a computer system that includes a microprocessor and a memory, the memory may have stored therein a computer program, and the microprocessor may operate in accordance with the computer program.

(10) Another independent computer system may perform the method by transporting the program or the digital signal recorded on the recording medium or by transporting the program or the digital signal via the network, for instance.

(11) The above embodiment and the above variations may be combined.

### INDUSTRIAL APPLICABILITY

The present disclosure is applicable to, for instance, an image determination device, an image determination method, and a program, in each of which machine learning models are used for defective/non-defective determination in inspection processes.

1. An image determination device comprising:
a trainer that obtains one or more first models by training one or more machine learning models of one or more types with use of a first training data set that includes first images and first labels associated with the first images, and obtains one or more second models by training one or more machine learning models of one or more types with use of one or more second training data sets each including second images, second labels associated with the second images, and at least part of the first training data set, the second images being different from the first images;
an image obtainer that obtains a target image; and
a determiner that outputs a determination result of a label of the target image obtained by the image obtainer, the determination result being obtained by using, for the target image, at least two models that include one of the one or more first models and one of the one or more second models.

2. The image determination device according to claim 1,
wherein the first images and the second images are inspection images of products obtained in a predetermined period.

3. The image determination device according to claim 2,
wherein among the inspection images,
the first images are inspection images obtained in a first period included in the predetermined period, and
the second images are inspection images obtained in a period after the first period, the period being included in the predetermined period.

4. The image determination device according to claim 2,
wherein a proportion of inspection images obtained on a particular date and time and included in one second training data set is higher than a proportion of inspection images obtained on the particular date and time and included in the first training data set, the one second training data set being included in the one or more second training data sets.

5. The image determination device according to claim 2,
wherein a proportion of inspection images obtained during inspection for a particular production line and included in one second training data set is higher than a proportion of inspection images obtained during inspection for the particular production line and included in the first training data set, the one second training data set being included in the one or more second training data sets.

6. The image determination device according to claim 1,
wherein the determiner further causes a third machine learning model to select a combination of at least one of the one or more first models and at least one of the one or more second models, the third machine learning model being trained using inputs that are one or more outputs from the one or more first models and one or more outputs from the one or more second models, and
the determiner outputs the determination result of the label of the target image, the determination result being a determination result obtained by using the combination selected.

7. The image determination device according to claim 1,
wherein the determiner combines, into a combined result, one or more determination results obtained by the one or more first models and one or more determination results obtained by the one or more second models in line with a preset rule, and outputs the combined result as the determination result of the label of the target image.

8. The image determination device according to claim 1, further comprising:
a display that displays a degree of precision of the determination result of the label of the target image, the degree of precision being obtained using, for a testing data set, a combination of at least one of the one or more first models and at least one of the one or more second models, the testing data set including part of the first training data set and part of each of the one or more second training data sets.

9. An image determination method comprising:
obtaining one or more first models by training one or more machine learning models of one or more types with use of a first training data set that includes first images and first labels associated with the first images, and obtaining one or more second models by training one or more machine learning models of one or more types with use of one or more second training data sets each including second images, second labels associated with the second images, and at least part of the first training data set, the second images being different from the first images;
obtaining a target image; and
outputting a determination result of a label of the target image obtained in the obtaining of the target image, the determination result being obtained by using, for the target image, at least two models that include one of the one or more first models and one of the one or more second models.

10. A non-transitory computer-readable recording medium having recorded thereon a program for causing a computer to execute:
obtaining one or more first models by training one or more machine learning models of one or more types with use of a first training data set that includes first images and first labels associated with the first images, and obtaining one or more second models by training one or more machine learning models of one or more types with use of one or more second training data sets each including second images, second labels associated with the second images, and at least part of the first training data set, the second images being different from the first images;
obtaining a target image; and
outputting a determination result of a label of the target image obtained in the obtaining of the target image, the determination result being obtained by using, for the target image, at least two models that include one of the one or more first models and one of the one or more second models.
